(19) United States
(12) Patent Application Publication
(10) Pub. No.: US 2024/0127828 A1
(43) Pub. Date: Apr. 18, 2024

(54) DETERMINATION OF SPATIAL AUDIO PARAMETER ENCODING AND ASSOCIATED DECODING

(71) Applicant: NOKIA TECHNOLOGIES OY, Espoo (FI)

(72) Inventors: Adriana VASILACHE, Tampere (FI); Anssi RÄMÖ, Tampere (FI); Lasse LAAKSONEN, Tampere (FI); Tapani PIHLAJAKUJA, Vantaa (FI); Mikko-Ville LAITINEN, Espoo (FI)

(21) Appl. No.: 18/263,494

(22) PCT Filed: Jan. 29, 2021
(86) PCT No.: PCT/EP2021/052201

§ 371 Date: Jul. 28, 2023

(51) Int. Cl. G10L 19/002; G10L 19/035; G10L 25/21

(52) U.S. Cl. CPC G10L 19/002; G10L 19/035; G10L 25/21

(57) ABSTRACT

An apparatus comprising means for: obtaining values for parameters representing an audio signal, the values comprising at least one directional value and at least one energy ratio value for each sub-band of at least two sub-bands of a frame of the audio signal; determining a penalty value for each sub-band; and on a sub-band by sub-band basis: selecting a sub-band based on the penalty value; and encoding, for the selected sub-band, the at least one directional value for each sub-band; distributing any bits allocated for encoding the selected sub-band at least one directional value which are not used in the encoding of the at least one directional value to succeeding selections of sub-bands.

### FIELD

The present application relates to apparatus and methods for sound-field related parameter encoding, but not exclusively for time-frequency domain direction related parameter encoding for an audio encoder and decoder.

### BACKGROUND

Parametric spatial audio processing is a field of audio signal processing where the spatial aspect of the sound is described using a set of parameters. For example, in parametric spatial audio capture from microphone arrays, it is a typical and an effective choice to estimate from the microphone array signals a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total energy ratios in frequency bands are thus a parameterization that is particularly effective for spatial audio capture.

A parameter set consisting of a direction parameter in frequency bands and an energy ratio parameter in frequency bands (indicating the directionality of the sound) can be also utilized as the spatial metadata (which may also include other parameters such as coherence, spread coherence, number of directions, distance etc) for an audio codec. For example, these parameters can be estimated from microphone-array captured audio signals, and for example a stereo signal can be generated from the microphone array signals to be conveyed with the spatial metadata. The stereo signal could be encoded, for example, with an AAC encoder. A decoder can decode the audio signals into PCM signals, and process the sound in frequency bands (using the spatial metadata) to obtain the spatial output, for example a binaural output.

The aforementioned solution is particularly suitable for encoding captured spatial sound from microphone arrays (e.g., in mobile phones, VR cameras, stand-alone microphone arrays). However, it may be desirable for such an encoder to have also other input types than microphone-array captured signals, for example, loudspeaker signals, audio object signals, or Ambisonic signals.

Analysing first-order Ambisonics (FOA) inputs for spatial metadata extraction has been thoroughly documented in scientific literature related to Directional Audio Coding (DirAC) and Harmonic planewave expansion (Harpex). This is since there exist microphone arrays directly providing a FOA signal (more accurately: its variant, the B-format signal), and analysing such an input has thus been a point of study in the field.

A further input for the encoder is also multi-channel loudspeaker input, such as 5.1 or 7.1 channel surround inputs.

However with respect to the directional components of the metadata, which may comprise an elevation, azimuth (and other parameters such as energy ratio) of a resulting direction, for each considered time/frequency subband. Quantization of these directional components is a current research topic.

### SUMMARY

There is provided according to a first aspect an apparatus comprising means for: obtaining values for parameters representing an audio signal, the values comprising at least one directional value and at least one energy ratio value for each sub-band of at least two sub-bands of a frame of the audio signal; determining a penalty value for each sub-band; and on a sub-band by sub-band basis: selecting a sub-band based on the penalty value; and encoding, for the selected sub-band, the at least one directional value for each sub-band; distributing any bits allocated for encoding the selected sub-band at least one directional value which are not used in the encoding of the at least one directional value to succeeding selections of sub-bands.

The means for determining a penalty value for each sub-band may be for: determining for the sub-bands an initial allocation of bits to encode the directional values of the frame based on the at least one energy ratio values; determining for the sub-bands a second allocation of bits to encode the directional values of the frame, the second allocation of bits being based on an available number of bits for encoding the values of the frame of the audio signal and a number of bits used in encoding the energy ratio values of the frame of the audio signal; determining a difference between the initial allocation of bits to encode the directional values and the second allocation of bits to encode the directional values of the frame.

The means for determining a penalty value for each sub-band may be for: obtaining a subjective perceptibility error measure associated with allocation of bits to encode the directional values of the frame; and determining a penalty value based on the obtained perceptibility error measure.

The means for determining a penalty value for each sub-band may be for: determining a weighting factor for each sub-band based on a direction value for a respective sub-band; and determining the penalty value for each sub-band based on the determined weighting factor.

The means for selecting a sub-band based on the penalty value may be for: ordering the sub-bands based on the difference between the initial allocation of bits to encode the directional values and the second allocation of bits to encode the directional values of the frame relative to the initial allocation of bits to encode the directional values; and selecting, on the sub-band by sub-band basis, the sub-bands based on the ordering of the sub-bands.

The bits allocated for encoding the selected sub-band at least one directional value may be based on the second allocation of bits to encode the directional values of the frame and any previous selected sub-band distribution.

The means for selecting a sub-band based on the penalty value may be for selecting an unencoded sub-band with the lowest penalty value.

The means for distributing any bits allocated for encoding the selected sub-band at least one directional value which are not used in the encoding of the at least one directional value to succeeding selections of sub-bands may be for distributing to a sub-band yet to be selected with the highest penalty value any bits allocated for encoding the selected sub-band at least one directional value which are not used in the encoding of the at least one directional value.

The means may be further for redetermining penalty values for each yet to be selected sub-band based on the distributing any bits allocated for encoding the selected sub-band at least one directional value which are not used in the encoding of the at least one directional value to succeeding selections of sub-bands.

The means may be further for encoding the at least one energy ratio values of the frame.

The means for encoding the at least one energy ratio values of the frame may be for: generating a weighted average of the at least one energy ratio value; and encoding the weighted average of the at least one energy ratio value.

The means for encoding the weighted average of the at least one energy ratio value may be further for scalar non-uniform quantizing the at least one weighted average of the at least one energy ratio value.

The means for encoding, for the selected sub-band, the at least one directional value for each sub-band, may be further for: determining a first number of bits required by encoding the at least one directional value for the selected sub-band based on a quantization grid; determining a second number of bits required by entropy encoding the at least one directional value for the selected sub-band; selecting either the quantization grid encoding or entropy encoding based on the lower number of bits used from the first number and the second number; and generating a signalling bit identifying the selection of the quantization grid encoding or entropy encoding.

The entropy encoding may be Golomb Rice encoding.

The means for may be further for: storing and/or transmitting the encoded at least one directional value.

According to a second aspect there is provided an apparatus comprising means for: obtaining encoded values for parameters representing an audio signal, the encoded values comprising at least one encoded directional value and at least one encoded energy ratio value for each sub-band of at least two sub-bands of a frame of the audio signal; determining a penalty value for each sub-band; and on a sub-band by sub-band basis: selecting a sub-band based on the penalty value; decoding, for the selected sub-band, the at least one directional value for each sub-band; and determining for succeeding selections of sub-bands a number of bits allocated for the encoded values of the at least one directional value.

The means for determining a penalty value for each sub-band may be for: determining for the sub-bands an initial allocation of bits for encoding the directional values of the frame based on the at least one energy ratio values; determining for the sub-bands a second allocation of bits which for encoding the directional values of the frame, the second allocation of bits being based on an available number of bits for encoding the directional values of the frame of the audio signal and a number of bits used in encoding the energy ratio values of the frame of the audio signal; and determining a difference between the initial allocation of bits to encode the directional values and the second allocation of bits to encode the directional values of the frame.

The means for determining a penalty value for each sub-band may be for: obtaining a subjective perceptibility error measure associated with allocation of bits to encode the directional values of the frame; and determining a penalty value based on the obtained perceptibility error measure.

The means for determining a penalty value for each sub-band may be for: determining a weighting factor for each sub-band based on a direction value for a respective sub-band; and determining the penalty value for each sub-band based on the determined weighting factor.

The means for selecting a sub-band based on the penalty value may be for: ordering the sub-bands based on the difference between the initial allocation of bits to encode the directional values and the second allocation of bits to encode the directional values of the frame relative to the initial allocation of bits to encode the directional values; and selecting, on the sub-band by sub-band basis, the sub-bands based on the ordering of the sub-bands.

The bits allocated for encoding the selected sub-band at least one directional value may be based on the second allocation of bits for encoding the directional values of the frame and any previous selected sub-band distribution.

The means for selecting a sub-band based on the penalty value may be for selecting an encoded sub-band with the lowest penalty value.

The means for distributing any bits allocated for encoding the selected sub-band at least one directional value which are not used in the encoding of the at least one directional value to succeeding selections of sub-bands may be for distributing to a sub-band yet to be selected with the highest penalty value any bits allocated for encoding the selected sub-band at least one directional value which are not used in the encoding of the at least one directional value.

The means may be further for redetermining penalty values for each yet to be selected sub-band based on the distributing any bits allocated for encoding the selected sub-band at least one directional value which are not used in the encoding of the at least one directional value to succeeding selections of sub-bands.

The means may be further for decoding the at least one energy ratio values of the frame.

The means for decoding, for the selected sub-band, the at least one directional value for each sub-band, may be further for: determining a signalling bit; and selecting either a quantization grid decoding or entropy decoding based on the signalling bit.

The entropy decoding may be Golomb Rice decoding.

According to a third aspect there is provided a method comprising: obtaining values for parameters representing an audio signal, the values comprising at least one directional value and at least one energy ratio value for each sub-band of at least two sub-bands of a frame of the audio signal; determining a penalty value for each sub-band; and on a sub-band by sub-band basis: selecting a sub-band based on the penalty value; and encoding, for the selected sub-band, the at least one directional value for each sub-band; distributing any bits allocated for encoding the selected sub-band at least one directional value which are not used in the encoding of the at least one directional value to succeeding selections of sub-bands.

Determining a penalty value for each sub-band may comprise: determining for the sub-bands an initial allocation of bits to encode the directional values of the frame based on the at least one energy ratio values; determining for the sub-bands a second allocation of bits to encode the directional values of the frame, the second allocation of bits being based on an available number of bits for encoding the values of the frame of the audio signal and a number of bits used in encoding the energy ratio values of the frame of the audio signal; determining a difference between the initial allocation of bits to encode the directional values and the second allocation of bits to encode the directional values of the frame.

Determining a penalty value for each sub-band may comprise: obtaining a subjective perceptibility error measure associated with allocation of bits to encode the directional values of the frame; and determining a penalty value based on the obtained perceptibility error measure.

Determining a penalty value for each sub-band may comprise: determining a weighting factor for each sub-band based on a direction value for a respective sub-band; and determining the penalty value for each sub-band based on the determined weighting factor.

Selecting a sub-band based on the penalty value may comprise: ordering the sub-bands based on the difference between the initial allocation of bits to encode the directional values and the second allocation of bits to encode the directional values of the frame relative to the initial allocation of bits to encode the directional values; and selecting, on the sub-band by sub-band basis, the sub-bands based on the ordering of the sub-bands.

The bits allocated for encoding the selected sub-band at least one directional value may be based on the second allocation of bits to encode the directional values of the frame and any previous selected sub-band distribution.

Selecting a sub-band based on the penalty value may comprise selecting an unencoded sub-band with the lowest penalty value.

Distributing any bits allocated for encoding the selected sub-band at least one directional value which are not used in the encoding of the at least one directional value to succeeding selections of sub-bands may comprise distributing to a sub-band yet to be selected with the highest penalty value any bits allocated for encoding the selected sub-band at least one directional value which are not used in the encoding of the at least one directional value.

The method may further comprise redetermining penalty values for each yet to be selected sub-band based on the distributing any bits allocated for encoding the selected sub-band at least one directional value which are not used in the encoding of the at least one directional value to succeeding selections of sub-bands.

The method may further comprise encoding the at least one energy ratio values of the frame.

Encoding the at least one energy ratio values of the frame may comprise: generating a weighted average of the at least one energy ratio value; and encoding the weighted average of the at least one energy ratio value.

Encoding the weighted average of the at least one energy ratio value may comprise scalar non-uniform quantizing the at least one weighted average of the at least one energy ratio value.

Encoding, for the selected sub-band, the at least one directional value for each sub-band, may comprise: determining a first number of bits required by encoding the at least one directional value for the selected sub-band based on a quantization grid; determining a second number of bits required by entropy encoding the at least one directional value for the selected sub-band; selecting either the quantization grid encoding or entropy encoding based on the lower number of bits used from the first number and the second number; and generating a signalling bit identifying the selection of the quantization grid encoding or entropy encoding.

The entropy encoding may be Golomb Rice encoding.

The method may further comprise: storing and/or transmitting the encoded at least one directional value.

According to a fourth aspect there is provided a method comprising: obtaining encoded values for parameters representing an audio signal, the encoded values comprising at least one encoded directional value and at least one encoded energy ratio value for each sub-band of at least two sub-bands of a frame of the audio signal; determining a penalty value for each sub-band; and on a sub-band by sub-band basis: selecting a sub-band based on the penalty value; decoding, for the selected sub-band, the at least one directional value for each sub-band; and determining for succeeding selections of sub-bands a number of bits allocated for the encoded values of the at least one directional value.

Determining a penalty value for each sub-band may comprise: determining for the sub-bands an initial allocation of bits for encoding the directional values of the frame based on the at least one energy ratio values; determining for the sub-bands a second allocation of bits which for encoding the directional values of the frame, the second allocation of bits being based on an available number of bits for encoding the directional values of the frame of the audio signal and a number of bits used in encoding the energy ratio values of the frame of the audio signal; and determining a difference between the initial allocation of bits to encode the directional values and the second allocation of bits to encode the directional values of the frame.

Determining a penalty value for each sub-band may comprise: obtaining a subjective perceptibility error measure associated with allocation of bits to encode the directional values of the frame; and determining a penalty value based on the obtained perceptibility error measure.

Determining a penalty value for each sub-band may comprise: determining a weighting factor for each sub-band based on a direction value for a respective sub-band; and determining the penalty value for each sub-band based on the determined weighting factor.

Selecting a sub-band based on the penalty value may comprise: ordering the sub-bands based on the difference between the initial allocation of bits to encode the directional values and the second allocation of bits to encode the directional values of the frame relative to the initial allocation of bits to encode the directional values; and selecting, on the sub-band by sub-band basis, the sub-bands based on the ordering of the sub-bands.

The bits allocated for encoding the selected sub-band at least one directional value may be based on the second allocation of bits for encoding the directional values of the frame and any previous selected sub-band distribution.

Selecting a sub-band based on the penalty value may comprise selecting an encoded sub-band with the lowest penalty value.

Distributing any bits allocated for encoding the selected sub-band at least one directional value which are not used in the encoding of the at least one directional value to succeeding selections of sub-bands may comprise distributing to a sub-band yet to be selected with the highest penalty value any bits allocated for encoding the selected sub-band at least one directional value which are not used in the encoding of the at least one directional value.

The method may comprise redetermining penalty values for each yet to be selected sub-band based on the distributing any bits allocated for encoding the selected sub-band at least one directional value which are not used in the encoding of the at least one directional value to succeeding selections of sub-bands.

The method may further comprise decoding the at least one energy ratio values of the frame.

Decoding, for the selected sub-band, the at least one directional value for each sub-band, may further comprise: determining a signalling bit; and selecting either a quantization grid decoding or entropy decoding based on the signalling bit.

The entropy decoding may be Golomb Rice decoding.

According to a fifth aspect there is provided an apparatus comprising at least one processor and at least one memory including a computer program code, the at least one memory and the computer program code configured to, with the at least one processor, cause the apparatus at least to: obtain values for parameters representing an audio signal, the values comprising at least one directional value and at least one energy ratio value for each sub-band of at least two sub-bands of a frame of the audio signal; determine a penalty value for each sub-band; and on a sub-band by sub-band basis: select a sub-band based on the penalty value; and encode, for the selected sub-band, the at least one directional value for each sub-band; distribute any bits allocated for encoding the selected sub-band at least one directional value which are not used in the encoding of the at least one directional value to succeeding selections of sub-bands.

The apparatus caused to determine a penalty value for each sub-band may be caused to: determine for the sub-bands an initial allocation of bits to encode the directional values of the frame based on the at least one energy ratio values; determine for the sub-bands a second allocation of bits to encode the directional values of the frame, the second allocation of bits being based on an available number of bits for encoding the values of the frame of the audio signal and a number of bits used in encoding the energy ratio values of the frame of the audio signal; determine a difference between the initial allocation of bits to encode the directional values and the second allocation of bits to encode the directional values of the frame.

The apparatus caused to determine a penalty value for each sub-band may be caused to: obtain a subjective perceptibility error measure associated with allocation of bits to encode the directional values of the frame; and determine a penalty value based on the obtained perceptibility error measure.

The apparatus caused to determine a penalty value for each sub-band may be caused to: determine a weighting factor for each sub-band based on a direction value for a respective sub-band; and determine the penalty value for each sub-band based on the determined weighting factor.

The apparatus caused to select a sub-band based on the penalty value may be caused to: order the sub-bands based on the difference between the initial allocation of bits to encode the directional values and the second allocation of bits to encode the directional values of the frame relative to the initial allocation of bits to encode the directional values; and select, on the sub-band by sub-band basis, the sub-bands based on the ordering of the sub-bands.

The bits allocated for encoding the selected sub-band at least one directional value may be based on the second allocation of bits to encode the directional values of the frame and any previous selected sub-band distribution.

The apparatus caused to select a sub-band based on the penalty value may be caused to select an unencoded sub-band with the lowest penalty value.

The apparatus caused to distribute any bits allocated for encoding the selected sub-band at least one directional value which are not used in the encoding of the at least one directional value to succeeding selections of sub-bands may be caused to distribute to a sub-band yet to be selected with the highest penalty value any bits allocated for encoding the selected sub-band at least one directional value which are not used in the encoding of the at least one directional value.

The apparatus may be further caused to redetermine penalty values for each yet to be selected sub-band based on the distributing any bits allocated for encoding the selected sub-band at least one directional value which are not used in the encoding of the at least one directional value to succeeding selections of sub-bands.

The apparatus may be further caused to encode the at least one energy ratio values of the frame.

The apparatus caused to encode the at least one energy ratio values of the frame may be caused to: generate a weighted average of the at least one energy ratio value; and encode the weighted average of the at least one energy ratio value.

The apparatus caused to encode the weighted average of the at least one energy ratio value may be further caused to scalar non-uniform quantize the at least one weighted average of the at least one energy ratio value.

The apparatus caused to encode, for the selected sub-band, the at least one directional value for each sub-band, may be further caused to: determine a first number of bits required by encoding the at least one directional value for the selected sub-band based on a quantization grid; determine a second number of bits required by entropy encoding the at least one directional value for the selected sub-band; select either the quantization grid encoding or entropy encoding based on the lower number of bits used from the first number and the second number; and generate a signalling bit identifying the selection of the quantization grid encoding or entropy encoding.

The entropy encoding may be Golomb Rice encoding.

The apparatus may be further caused to: store and/or transmit the encoded at least one directional value.

According to a sixth aspect there is provided an apparatus comprising at least one processor and at least one memory including a computer program code, the at least one memory and the computer program code configured to, with the at least one processor, cause the apparatus at least to: obtain encoded values for parameters representing an audio signal, the encoded values comprising at least one encoded directional value and at least one encoded energy ratio value for each sub-band of at least two sub-bands of a frame of the audio signal; determine a penalty value for each sub-band; and on a sub-band by sub-band basis: select a sub-band based on the penalty value; decode, for the selected sub-band, the at least one directional value for each sub-band; and determine for succeeding selections of sub-bands a number of bits allocated for the encoded values of the at least one directional value.

The apparatus caused to determine a penalty value for each sub-band may be caused to: determine for the sub-bands an initial allocation of bits for encoding the directional values of the frame based on the at least one energy ratio values; determine for the sub-bands a second allocation of bits which for encoding the directional values of the frame, the second allocation of bits being based on an available number of bits for encoding the directional values of the frame of the audio signal and a number of bits used in encoding the energy ratio values of the frame of the audio signal; and determine a difference between the initial allocation of bits to encode the directional values and the second allocation of bits to encode the directional values of the frame.

The apparatus caused to determine a penalty value for each sub-band may be caused to: obtain a subjective perceptibility error measure associated with allocation of bits to encode the directional values of the frame; and determine a penalty value based on the obtained perceptibility error measure.

The apparatus caused to determine a penalty value for each sub-band may be caused to: determine a weighting factor for each sub-band based on a direction value for a respective sub-band; and determine the penalty value for each sub-band based on the determined weighting factor.

The apparatus caused to select a sub-band based on the penalty value may be caused to: order the sub-bands based on the difference between the initial allocation of bits to encode the directional values and the second allocation of bits to encode the directional values of the frame relative to the initial allocation of bits to encode the directional values; and select, on the sub-band by sub-band basis, the sub-bands based on the ordering of the sub-bands.

The bits allocated for encoding the selected sub-band at least one directional value may be based on the second allocation of bits for encoding the directional values of the frame and any previous selected sub-band distribution.

The apparatus caused to select a sub-band based on the penalty value may be caused to select an encoded sub-band with the lowest penalty value.

The apparatus caused to distribute any bits allocated for encoding the selected sub-band at least one directional value which are not used in the encoding of the at least one directional value to succeeding selections of sub-bands may be caused to distribute to a sub-band yet to be selected with the highest penalty value any bits allocated for encoding the selected sub-band at least one directional value which are not used in the encoding of the at least one directional value.

The apparatus may be further caused to redetermine penalty values for each yet to be selected sub-band based on the distributing any bits allocated for encoding the selected sub-band at least one directional value which are not used in the encoding of the at least one directional value to succeeding selections of sub-bands.

The apparatus may be further caused to decode the at least one energy ratio values of the frame.

The apparatus caused to decode, for the selected sub-band, the at least one directional value for each sub-band, may be further caused to: determine a signalling bit; and select either a quantization grid decoding or entropy decoding based on the signalling bit.

The entropy decoding may be Golomb Rice decoding.

According to a seventh aspect there is provided an apparatus comprising: means for obtaining values for parameters representing an audio signal, the values comprising at least one directional value and at least one energy ratio value for each sub-band of at least two sub-bands of a frame of the audio signal; means for determining a penalty value for each sub-band; and on a sub-band by sub-band basis: means for selecting a sub-band based on the penalty value; and means for encoding, for the selected sub-band, the at least one directional value for each sub-band; means for distributing any bits allocated for encoding the selected sub-band at least one directional value which are not used in the encoding of the at least one directional value to succeeding selections of sub-bands.

According to an eighth aspect there is provided an apparatus comprising means for obtaining encoded values for parameters representing an audio signal, the encoded values comprising at least one encoded directional value and at least one encoded energy ratio value for each sub-band of at least two sub-bands of a frame of the audio signal; means for determining a penalty value for each sub-band; and on a sub-band by sub-band basis: means for selecting a sub-band based on the penalty value; means for decoding, for the selected sub-band, the at least one directional value for each sub-band; and means for determining for succeeding selections of sub-bands a number of bits allocated for the encoded values of the at least one directional value.

According to a ninth aspect there is provided a computer program comprising instructions [or a computer readable medium comprising program instructions] for causing an apparatus to perform at least the following: obtaining values for parameters representing an audio signal, the values comprising at least one directional value and at least one energy ratio value for each sub-band of at least two sub-bands of a frame of the audio signal; determining a penalty value for each sub-band; and on a sub-band by sub-band basis: selecting a sub-band based on the penalty value; and encoding, for the selected sub-band, the at least one directional value for each sub-band; distributing any bits allocated for encoding the selected sub-band at least one directional value which are not used in the encoding of the at least one directional value to succeeding selections of sub-bands.

According to a tenth aspect there is provided a computer program comprising instructions [or a computer readable medium comprising program instructions] for causing an apparatus to perform at least the following: obtaining circuitry configured to obtain encoded values for parameters representing an audio signal, the encoded values comprising at least one encoded directional value and at least one encoded energy ratio value for each sub-band of at least two sub-bands of a frame of the audio signal; determining circuitry configured to determine a penalty value for each sub-band; and on a sub-band by sub-band basis: selecting circuitry configured to select a sub-band based on the penalty value; decoding circuitry configured to, for the selected sub-band, the at least one directional value for each sub-band; and determining circuitry configured to determine for succeeding selections of sub-bands a number of bits allocated for the encoded values of the at least one directional value.

According to an eleventh aspect there is provided a non-transitory computer readable medium comprising program instructions for causing an apparatus to perform at least the following: obtaining values for parameters representing an audio signal, the values comprising at least one directional value and at least one energy ratio value for each sub-band of at least two sub-bands of a frame of the audio signal; determining a penalty value for each sub-band; and on a sub-band by sub-band basis: selecting a sub-band based on the penalty value; and encoding, for the selected sub-band, the at least one directional value for each sub-band; distributing any bits allocated for encoding the selected sub-band at least one directional value which are not used in the encoding of the at least one directional value to succeeding selections of sub-bands.

According to a twelfth aspect there is provided a non-transitory computer readable medium comprising program instructions for causing an apparatus to perform at least the following: obtaining encoded values for parameters representing an audio signal, the encoded values comprising at least one encoded directional value and at least one encoded energy ratio value for each sub-band of at least two sub-bands of a frame of the audio signal; determining a penalty value for each sub-band; and on a sub-band by sub-band basis: selecting a sub-band based on the penalty value; decoding, for the selected sub-band, the at least one directional value for each sub-band; and determining for succeeding selections of sub-bands a number of bits allocated for the encoded values of the at least one directional value.

According to a thirteenth aspect there is provided an apparatus comprising: obtaining circuitry configured to obtaining values for parameters representing an audio signal, the values comprising at least one directional value and at least one energy ratio value for each sub-band of at least two sub-bands of a frame of the audio signal; determining circuitry configured to determine a penalty value for each sub-band; and circuitry configured on a sub-band by sub-band basis for: selecting a sub-band based on the penalty value; and encoding, for the selected sub-band, the at least one directional value for each sub-band; distributing any bits allocated for encoding the selected sub-band at least one directional value which are not used in the encoding of the at least one directional value to succeeding selections of sub-bands.

According to a fourteenth aspect there is provided an apparatus comprising: obtaining circuitry configured to obtain encoded values for parameters representing an audio signal, the encoded values comprising at least one encoded directional value and at least one encoded energy ratio value for each sub-band of at least two sub-bands of a frame of the audio signal; determining circuitry configured to determine a penalty value for each sub-band; and circuitry configured to on a sub-band by sub-band basis: select a sub-band based on the penalty value; decode, for the selected sub-band, the at least one directional value for each sub-band; and determine for succeeding selections of sub-bands a number of bits allocated for the encoded values of the at least one directional value.

According to a fifteenth aspect there is provided a computer readable medium comprising program instructions for causing an apparatus to perform at least the following: obtaining values for parameters representing an audio signal, the values comprising at least one directional value and at least one energy ratio value for each sub-band of at least two sub-bands of a frame of the audio signal; determining a penalty value for each sub-band; and on a sub-band by sub-band basis: selecting a sub-band based on the penalty value; and encoding, for the selected sub-band, the at least one directional value for each sub-band; distributing any bits allocated for encoding the selected sub-band at least one directional value which are not used in the encoding of the at least one directional value to succeeding selections of sub-bands.

According to a sixteenth aspect there is provided a computer readable medium comprising program instructions for causing an apparatus to perform at least the following: obtaining encoded values for parameters representing an audio signal, the encoded values comprising at least one encoded directional value and at least one encoded energy ratio value for each sub-band of at least two sub-bands of a frame of the audio signal; determining a penalty value for each sub-band; and on a sub-band by sub-band basis: selecting a sub-band based on the penalty value; decoding, for the selected sub-band, the at least one directional value for each sub-band; and determining for succeeding selections of sub-bands a number of bits allocated for the encoded values of the at least one directional value.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically the metadata encoder according to some embodiments;

FIG. 3 show a flow diagram of the operation of the metadata encoder as shown in FIG. 2 according to some embodiments;

FIG. 4 shows schematically the metadata decoder according to some embodiments;

FIG. 5 show a flow diagram of the operation of a metadata decoder as shown in FIG. 4 according to some embodiments; and

FIG. 6 shows schematically an example device suitable for implementing the apparatus shown.

### EMBODIMENTS OF THE APPLICATION

The following describes in further detail suitable apparatus and possible mechanisms for the provision of effective spatial analysis derived metadata parameters. In the following discussions multi-channel system is discussed with respect to a multi-channel microphone implementation. However as discussed above the input format may be any suitable input format, such as multi-channel loudspeaker, ambisonic (FOA/HOA) etc. It is understood that in some embodiments the channel location is based on a location of the microphone or is a virtual location or direction. Furthermore the output of the example system is a multi-channel loudspeaker arrangement. However it is understood that the output may be rendered to the user via means other than loudspeakers. Furthermore the multi-channel loudspeaker signals may be generalised to be two or more playback audio signals.

The metadata consists at least of elevation, azimuth and the energy ratio of a resulting direction, for each considered time/frequency subband. The direction parameter components, the azimuth and the elevation are extracted from the audio data and then quantized to a given quantization resolution. The resulting indexes must be further compressed for efficient transmission. For high bitrate, high quality lossless encoding of the metadata is needed.

The concept as discussed hereafter is to implement a combined fixed bitrate coding approach with variable bitrate coding that distributes encoding bits for data to be compressed between different segments, such that the overall bitrate per frame is fixed. Within the time frequency blocks, the bits can be transferred between frequency sub-bands. Furthermore the concept expands on this by being configured to modify the subband encoding order in such way that the original (e.g., based on energy ratio) direction quantization accuracy and the reduced direction quantization accuracy are used to obtain quantization resolution penalty value per subband. This penalty value is then used to control the ordering of the processing of the subbands.

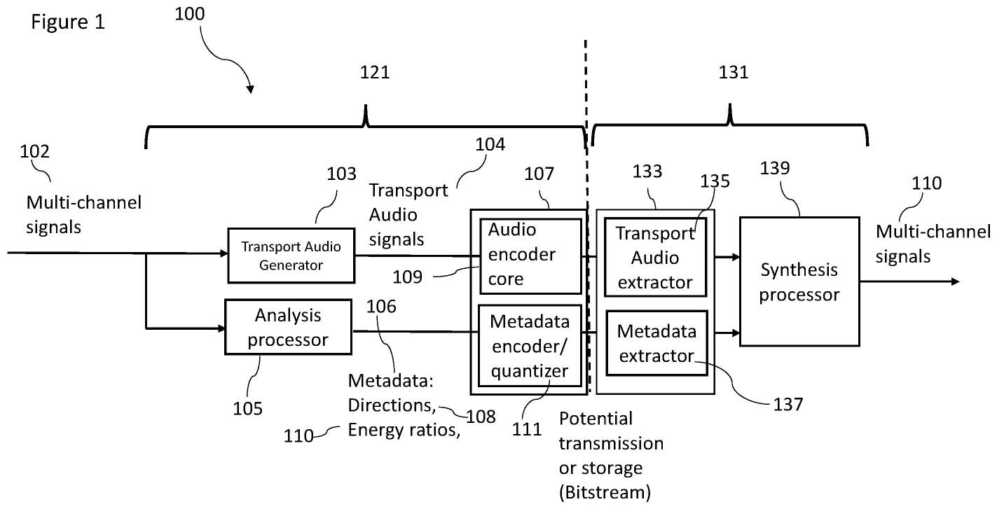

With respect to FIG. 1 an example apparatus and system for implementing embodiments of the application are shown. The system 100 is shown with an ‘analysis’ part 121 and a ‘synthesis’ part 131. The ‘analysis’ part 121 is the part from receiving the multi-channel signals up to an encoding of the metadata and a suitable transport audio signal and the ‘synthesis’ part 131 is the part from a decoding of the encoded metadata and transport audio signal to the presentation and rendering of a spatial audio signal (for example in multi-channel loudspeaker form).

The input to the system 100 and the ‘analysis’ part 121 is the multi-channel signals 102. In the following examples a microphone channel signal input is described, however any suitable input (or synthetic multi-channel) format may be implemented in other embodiments. For example in some embodiments the spatial analyser and the spatial analysis may be implemented external to the encoder. For example in some embodiments the spatial metadata associated with the audio signals may be a provided to an encoder as a separate bit-stream. In some embodiments the spatial metadata may be provided as a set of spatial (direction) index values.

The multi-channel signals are passed to a transport audio generator 103 and to an analysis processor 105.

In some embodiments the transport audio generator 103 is configured to receive the multi-channel signals and generate a suitable transport audio signal or signals. For example the transport audio signals may be a selection of one or more of the input audio signal channels. In some embodiments the transport audio generator 103 is configured to downmix the audio signal channels to a determined number of channels and output these as transport audio signals 104. For example the transport audio generator 103 may be configured to generate a 2 channel audio signal downmix of the multi-channel signals. The determined number of channels may be any suitable number of channels. In some embodiments the transport audio generator 103 is optional and the multi-channel signals are passed unprocessed to an encoder 107 in the same manner as the processed versions of the transport audio signals.

In some embodiments the analysis processor 105 is also configured to receive the multi-channel signals and analyse the signals to produce metadata 106 associated with the multi-channel signals and thus associated with the transport audio signals 104. The analysis processor 105 may be configured to generate the metadata which may comprise, for each time-frequency analysis interval, a direction parameter 108 and an energy ratio parameter 110 (and in some embodiments a coherence parameter, and a diffuseness parameter). The direction and energy ratio may in some embodiments be considered to be spatial audio parameters. In other words the spatial audio parameters comprise parameters which aim to characterize the sound-field created by the multi-channel signals (or two or more playback audio signals in general).

In some embodiments the parameters generated may differ from frequency band to frequency band. Thus for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons. The transport audio signals 104 and the metadata 106 may be passed to an encoder 107.

The encoder 107 may comprise an audio encoder core 109 which is configured to receive the transport audio signals 104 and generate a suitable encoding of these audio signals. The encoder 107 can in some embodiments be a computer (running suitable software stored on memory and on at least one processor), or alternatively a specific device utilizing, for example, FPGAs or ASICs. The encoding may be implemented using any suitable scheme. The encoder 107 may furthermore comprise a metadata encoder/quantizer 111 which is configured to receive the metadata and output an encoded or compressed form of the information. In some embodiments the encoder 107 may further interleave, multiplex to a single data stream or embed the metadata within encoded transport audio signals before transmission or storage shown in FIG. 1 by the dashed line. The multiplexing may be implemented using any suitable scheme.

In the decoder side, the received or retrieved data (stream) may be received by a decoder/demultiplexer 133. The decoder/demultiplexer 133 may demultiplex the encoded streams and pass the audio encoded stream to a downmix extractor 135 which is configured to decode the audio signals to obtain the transport audio signals. Similarly the decoder/demultiplexer 133 may comprise a metadata extractor 137 which is configured to receive the encoded metadata and generate metadata. The decoder/demultiplexer 133 can in some embodiments be a computer (running suitable software stored on memory and on at least one processor), or alternatively a specific device utilizing, for example, FPGAs or ASICs.

The decoded metadata and transport audio signals may be passed to a synthesis processor 139.

The system 100 ‘synthesis’ part 131 further shows a synthesis processor 139 configured to receive the transport audio signals and the metadata and re-creates in any suitable format a synthesized spatial audio in the form of multi-channel signals 110 (these may be multichannel loudspeaker format or in some embodiments any suitable output format such as binaural or Ambisonics signals, depending on the use case) based on the transport audio signals and the metadata.

Therefore in summary first the system (analysis part) is configured to receive multi-channel audio signals.

Then the system (analysis part) is configured to generate transport audio signals (for example by selecting some of the audio signal channels).

The system is then configured to encode for storage/transmission the transport audio signals.

Furthermore the system is configured to generate (for example by analysis of the multi-channel audio signals the spatial parameters or spatial metadata.

The obtained spatial metadata may then be encoded for storage/transmission.

After this the system may store/transmit the encoded transport audio signals and metadata.

The system may retrieve/receive the encoded transport audio signals and metadata.

Then the system is configured to extract the transport audio signals and metadata from encoded transport audio signals and metadata parameters, for example demultiplex and decode the encoded transport audio signals and metadata parameters.

The system (synthesis part) is configured to synthesize an output multi-channel audio signal based on extracted transport audio signals and metadata.

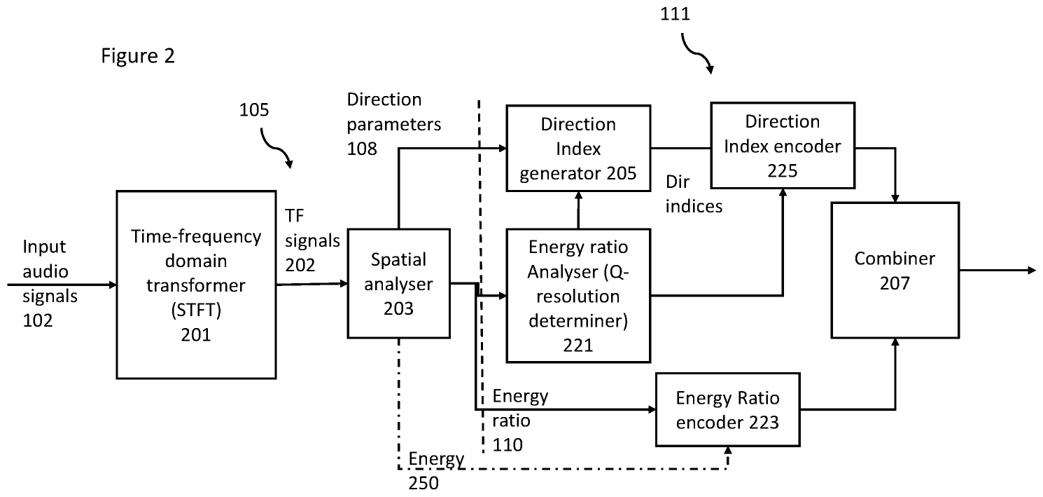

With respect to FIG. 2 an example analysis processor 105 and Metadata encoder/quantizer 111 (as shown in FIG. 1) according to some embodiments is described in further detail.

The analysis processor 105 in some embodiments comprises a time-frequency domain transformer 201.

In some embodiments the time-frequency domain transformer 201 is configured to receive the multi-channel signals 102 and apply a suitable time to frequency domain transform such as a Short Time Fourier Transform (STFT) in order to convert the input time domain signals into a suitable time-frequency signals. These time-frequency signals may be passed to a spatial analyser 203.

Thus for example the time-frequency signals 202 may be represented in the time-frequency domain representation by

sᵢ(b,n),

where b is the frequency bin index and n is the time-frequency block (frame) index and i is the channel index. In another expression, n can be considered as a time index with a lower sampling rate than that of the original time-domain signals. These frequency bins can be grouped into subbands that group one or more of the bins into a subband of a band index k=0, . . . , K−1. Each subband k has a lowest bin b_{k,low} and a highest bin b_{k,high}, and the subband contains all bins from b_{k,low} to b_{k,high}. The widths of the subbands can approximate any suitable distribution. For example the Equivalent rectangular bandwidth (ERB) scale or the Bark scale.

In some embodiments the analysis processor 105 comprises a spatial analyser 203. The spatial analyser 203 may be configured to receive the time-frequency signals 202 and based on these signals estimate direction parameters 108. The direction parameters may be determined based on any audio based ‘direction’ determination.

For example in some embodiments the spatial analyser 203 is configured to estimate the direction with two or more signal inputs.

The spatial analyser 203 may thus be configured to provide at least one azimuth and elevation for each frequency band and temporal time-frequency block within a frame of an audio signal, denoted as azimuth φ(k,n) and elevation θ(k,n). The direction parameters 108 may be also be passed to a direction index generator 205.

The spatial analyser 203 may also be configured to determine an energy ratio parameter 110. The energy ratio may be considered to be a determination of the energy of the audio signal which can be considered to arrive from a direction. The direct-to-total energy ratio r(k,n) can be estimated, e.g., using a stability measure of the directional estimate, or using any correlation measure, or any other suitable method to obtain a ratio parameter. The energy ratio may be passed to an energy ratio analyser 221 and an energy ratio combiner 223.

In some embodiments the spatial analyser 203 is configured to determine a (total) energy value 250. The energy value 250 can in such embodiments be passed to an energy ratio encoder 223 and be used to determine a number of bits used to encode the energy ratio 110.

Therefore in summary the analysis processor is configured to receive time domain multichannel or other format such as microphone or ambisonic audio signals.

Following this the analysis processor may apply a time domain to frequency domain transform (e.g., STFT) to generate suitable time-frequency domain signals for analysis and then apply direction analysis to determine direction and energy ratio parameters.

The analysis processor may then be configured to output the determined parameters.

Although directions and ratios are here expressed for each time index n, in some embodiments the parameters may be combined over several time indices. Same applies for the frequency axis, as has been expressed, the direction of several frequency bins b could be expressed by one direction parameter in band k consisting of several frequency bins b. The same applies for all of the discussed spatial parameters herein.

As also shown in FIG. 2 an example metadata encoder/quantizer 111 is shown according to some embodiments.

The metadata encoder/quantizer 111 may comprise an energy ratio analyser (or quantization resolution determiner) 221. The energy ratio analyser 221 may be configured to receive the energy ratios and from the analysis generate a quantization resolution for the direction parameters (in other words a quantization resolution for elevation and azimuth values) for all of the time-frequency blocks in the frame. This bit allocation may for example be defined by bits_dir0[0:N−1][0:M−1].

The metadata encoder/quantizer 111 may comprise a direction index generator 205. The direction index generator 205 is configured to receive the direction parameters (such as the azimuth φ(k, n) and elevation θ(k, n) 108 and the quantization bit allocation and from this generate a quantized output. In some embodiments the quantization is based on an arrangement of spheres forming a spherical grid arranged in rings on a ‘surface’ sphere which are defined by a look up table defined by the determined quantization resolution. In other words the spherical grid uses the idea of covering a sphere with smaller spheres and considering the centres of the smaller spheres as points defining a grid of almost equidistant directions. The smaller spheres therefore define cones or solid angles about the centre point which can be indexed according to any suitable indexing algorithm. Although spherical quantization is described here any suitable quantization, linear or non-linear may be used.

For example in some embodiments the bits for direction parameters (azimuth and elevation) are allocated according to the table bits_direction[ ]; if the energy ratio has the index i, the number of bits for the direction is bits_direction[i].

const short bits direction[ ]={3,5,6,8,9,10,11,11};

The structure of the direction quantizers for different bit resolutions is given by the following variables:

| const short no_theta[ ] = /* from 1 to 11 bits */ | |
|---|---|
| {/*1, | − 1 bit |
| 1,*/ | /* 2 bits */ |
| 1, | /* 3 bits * / |
| 2, | /* 4 bits */ |
| 4, | /* 5 bits */ |
| 5, | /* 6 bits */ |
| 6, | /* 7 bits */ |
| 7, | /* 8 bits */ |
| 10, | /* 9 bits */ |
| 14, | /* 10 bits */ |
| 19 | /* 11 bits */ |

};
const short no_phi[ ][MAX_NO_THETA] =
/* from 1 to 11 bits*/
{
{2},
{4},
{8},
{12,4}, /* no points at poles */
{12,7,2,1},
{14,13,9,2,1},
{22,21,17, 11,3,1},
{33,32,29,23,17,9,1},
{48,47,45,41,35,28,20,12,2,1},
{60,60,58,56,54,50,46,41,36,30,23,17,10,1},
{89,89,88,86,84,81,77,73,68,63,57,51,44,38,30,23,15,8,1}
};

‘no_theta’ corresponds to the number of elevation values in the ‘North hemisphere’ of the sphere of directions, including the Equator. ‘no_phi’ corresponds to the number of azimuth values at each elevation for each quantizer.

For instance for 5 bits there are 4 elevation values corresponding to [0, 30, 60, 90] and 4−1=3 negative elevation values [−30, −60, −90]. For the first elevation value, 0, there are 12 equidistant azimuth values, for the elevation values 30 and −30 there are 7 equidistant azimuth values and so on.

All quantization structures with the exception of the structure corresponding to 4 bits have the difference between consecutive elevation values given by 90 degrees divided by the number of elevation values ‘no_theta’. The structure corresponding to 4 bits has points only for the elevation having value of 0 and +45 degrees. There are no points under the Equator line for this structure. This is an example and any other suitable distribution may be implemented. For example in some embodiments there may be implemented a spherical grid for 4 bits that has points also under the Equator. Similarly the 3 bits distribution may be spread on the sphere or restricted to the Equator only.

The quantization indices for sub-bands within a group of time-blocks may then be passed to a direction index encoder 225.

In some embodiments the encoder comprises an energy ratio encoder 223. The energy ratio encoder 223 may be configured to receive the determined energy ratios (for example direct-to-total energy ratios, and furthermore diffuse-to-total energy ratios and remainder-to-total energy ratios) and encode/quantize these.

For example in some embodiments the energy ratio encoder 223 is configured to apply a scalar non-uniform quantization using 3 bits for each sub-band.

Furthermore in some embodiments the energy ratio encoder 223 is configured to generate one weighted average value per subband. In some embodiments this average is computed by taking into account the total energy 250 of each time-frequency block and the weighting applied based on the subbands having more energy.

The energy ratio encoder 223 may then pass this to a combiner 207 which is configured to combine the metadata and output a combined encoded metadata.

In some embodiments the encoder comprises a direction index encoder 225. The direction index encoder 225 may be configured to obtain and encode the index values on a sub-band by sub-band basis.

The direction index encoder 225 thus may be configured to reduce the allocated number of bits to a value bits_dir1[0:N−1][0:M−1], such that the sum of the allocated bits equals the number of available bits left after encoding the energy ratios.

The reduction of the number of initially allocated bits, in other words

bits_dir1[0:N−1][0:M−1] from bits_dir0[0:N−1][0:M−1] may be implemented in some embodiments by:

Firstly uniformly diminishing the number of bits across time/frequency block with an amount of bits given by the integer division between the bits to be reduced and the number of time-frequency blocks;

Secondly, the bits that still need to be subtracted are subtracted one per time-frequency block starting with subband 0, time-frequency block 0.

This may be implemented for example by the following c code:

```
void
only_reduce_bits_direction (short
bits_dir0[MASA_MAXIMUM_CODING_
SUBBANDS][MASA_SUBFRAMES],
  short max_bits, short reduce_bits,
  short coding_subbands, short
no_subframes, IVAS_MASA_QDIRECTION * qdirection)
{
  /* does not update the q_direction structure */
  int j, k, bits = 0, red_times, rem, n = 0;
  /* keep original allocation */
  for (j = 0; j < coding_subbands; j++)
  {
    for (k = 0; k < no_subframes; k++)
    {
      qdirection−>bits_sph_idx[j][k] = bits_dir0[j][k];
    }
  }
  if (reduce_bits > 0)
  {
    red_times = reduce_bits /
    (coding_subbands*no_subframes) ;
    /* number of complete reductions by 1 bit */
    for (j = 0; j < coding_subbands; j++)
    {
      for (k = 0; k < no_subframes; k++)
      {
        bits_dir0[j][k] −= red_times;
        if (bits_dir0[j][k] < 0)
        {
          reduce_bits += −bits_dir0[j][k];
          bits_dir0[j][k] = 0;
        }
      }
    }
    rem = reduce_bits −
    coding_subbands*no_subframes*red_times;
    for (j = 0; j < coding_subbands; j++)
    {
      for (k = 0; k < no_subframes; k++)
      {
        if ((n < rem) && (bits_dir0[j][k] > 0))
        {
          bits_dir0[j][k] −= 1;
            n++;
        }
      }
    }
  }
  return;
}
```

In some embodiments, a minimum number of bits, larger than 0, may be imposed for each block.

In some embodiments then a relative bit penalty parameter may be determined.

The relative bit penalty parameter for each time frequency tile is calculated in some embodiments as the difference between the original bit allocation, bits_dir0[0:N−1][0:M−1] and the reduced bit allocation, bits_dir1[0:N−1][0:M−1] over the original bit allocation value.

This may be implemented as

$$Rel\_bit \_penalty [ 0 : N - 1 ] [ 0 : M - 1 ] = \frac{b i t {s}_{-} d i r 0 [ 0 : N - 1 ] [ 0 : M - 1 ] - b i t {s}_{-} d i r 1 [ 0 : N - 1 ] [ 0 : M - 1 ] )}{b i t {s}_{-} dir 0 [ 0 : N - 1 ] [ 0 : M - 1 ]}$$

The average bit penalty is obtained as average penalty value over the subframes of one subband.

Thus the average bit penalty may be calculated as:

$$Av\_bit \_penalty [ 0 : N - 1 ] = \frac{1}{M} {\sum }_{K = 0}^{K = M - 1} Rel\_bit \_penalty [ 0 : N - 1 ] [ 0 : M - 1 ] .$$

Having determined average bit penalty this value may then be used to order the subbands such that the ordering goes from the lowest to the highest penalty values. In some embodiments in case of an equal average bit penalty (or tie) then the ordering of the subbands can be based on the which subband has been left with more bits after reduction being ordered before the subband with fewer bits.

Thus for example, suppose we have the following initial bit allocation for each time frequency tile (where the rows indicate subbands and the columns time samples):

$$bits\_dir 0 [ 0 : N - 1 ] [ 0 : M - 1 ] = [ \begin{matrix}7 & 7 & 7 & 7 \\ 10 & 10 & 10 & 10 \\ 11 & 11 & 11 & 11 \\ 6 & 6 & 6 & 6 \\ 5 & 5 & 5 & 5\end{matrix} ]$$

and after reduction the bit allocation becomes:

$$bits\_dir 1 [ 0 : N - 1 ] [ 0 : M - 1 ] = [ \begin{matrix}5 & 5 & 5 & 5 \\ 8 & 8 & 8 & 8 \\ 9 & 9 & 9 & 9 \\ 4 & 5 & 5 & 5 \\ 4 & 4 & 4 & 4\end{matrix} ]$$

As consequence the average relative penalty for each subband is:

Av_bit_penalty[0:N−1]=[0.28 0.20 0.18 0.21 0.20].

For example the first subband the penalty is calculated as follows: (7−5)/7+(7−5)/7+(7−5)/7+(7−5)/7)/4=0.28 corresponding to the average of difference between initial and reduced bit allocations relative to the initial bit allocation, the average being taken over the subband.

In this example the second and fifth subband have same average relative penalty, but the number of bits for the second subband is 8×4=32 while the number of bits for the fifth subband is 4×4=16, therefore the order in which the subbands will be encoded is:

ord=[5 2 1 4 3].

The direction index encoder 225 may then be configured to implement a further adjustment or redistribution (which may include a reduction) of the number of bits on a sub-band by sub-band basis based on the ordering of the subbands.

The ordering of the subbands thus allows us when encoding to increase the chances of distributing bits to the next subband in line. Thus the aim is to configure an encoding method where there is a reduction of bits (but not a decrease in resolution) for the subband providing the bit allocation and an increase in bits (and also increase in resolution) for the subband receiving the bit allocation.

For example, in some embodiments, the direction index encoder 225 may be configured to calculate the number of allowed bits for a current sub-band from the first ordered sub-band ord[1] to the penultimate sub-band ord[N−1]. In other words to determine the following

bits_allowed=sum(bits_dir1[i][0:M−1]) from i=1 to N−1.

The direction index encoder may then be configured to attempt to encode the direction parameter indexes using a suitable entropy coding and determine how many bits are required for the current sub-band (bits_ec). Where this is less than a suitable fixed rate encoding mechanism using the determined reduced allocated number of bits, bits_fixed=bits_allowed, then the entropy coding is selected. Otherwise the fixed rate encoding method is selected.

Furthermore one bit is used to indicate the method selected.

In other words the number of bits used to encode the sub-band direction index is:

nb=min(bits_fixed,bits_ec)+1;

The direction index encoder may then be configured to determine whether there are bits remaining from the sub-band ‘pool’ of available bits.

For example the direction index encoder 225 may be configured to determine a difference value

diff=(allowed_bits−nb)

Where diff>0, in other words there are unused bits from the allocation then these bits may be redistributed to succeeding sub-bands. For example by updating the distribution defined by the array bits_dir1[i+1:N−1][0:M−1].

Where diff=0 or <0 then subtract one bit from the allocation from the succeeding sub-band allocation. For example by updating the distribution defined by the array bits_dir1 [i+1][0]

Having encoded all except the last ordered sub-band then the last ordered sub-band ord[N] index values are encoded using a fixed rate encoding using a bit allocation defined by dir1[N−1][0:M−1] bits.

These may then be passed to a combiner 207 where the combined encoded direction and energy values are combined and output.

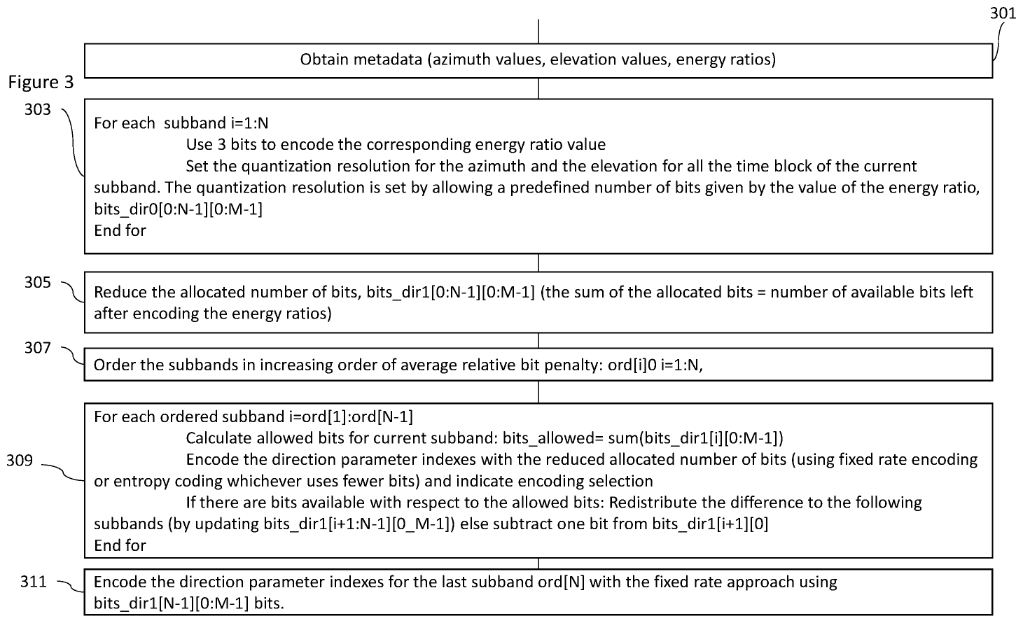

With respect to FIG. 3 is shown the operation of the Metadata encoder/quantizer 111 as shown in FIG. 2.

An initial operation is one of obtaining metadata (azimuth values, elevation values, energy ratios) as shown in FIG. 3 by step 301.

Having obtained the metadata for each sub-band (i=1:N) prepare an initial distribution or allocation and as shown by FIG. 3 by step 303: use 3 bits to encode the corresponding energy ratio value and then set the quantization resolution for the azimuth and the elevation for all the time-frequency blocks of the current subband. The quantization resolution is set by allowing a predefined number of bits given by the value of the energy ratio, bits_dir0[0:N−1][0:M−1].

Having generated an initial allocation reduce the allocated number of bits, bits_dir1 [0:N−1][0:M−1] (the sum of the allocated bits=number of available bits left after encoding the energy ratios) as shown in FIG. 3 by step 305.

The method may then determine an average relative bit penalty and furthermore order the subbands in increasing order of average relative bit penalty: ord[i]0 i=1:N as shown in FIG. 3 by step 307.

Having ordered the subbands (based on the average relative bit penalty) then the reduced bit allocation for each subband is implemented on an ordered subband basis from the first ordered subband ord[1] to the penultimate subband ord[N−1] (or where there are zero bits allocated for the last ordered subband, then the “bit passing” procedure may be implemented only up to the ordered subband before the penultimate ordered subband Ord[1:N−2]) subband (in other words For each ordered subband ord[i=1: N−1]): calculate the allowed bits for current subband: bits_allowed=sum(bits_dir1 [i][0:M−1]). Encode the direction parameter indexes with the reduced allocated number of bits (using fixed rate encoding or entropy coding whichever uses fewer bits) and indicate encoding selection. If there are bits available with respect to the allowed bits: Redistribute the difference to the following subbands (by updating bits_dir1[i+1:N−1][0_M−1]) else subtract one bit from bits_dir1 [i+1][0]. This is shown in FIG. 3 by step 309.

Then for the final ordered sub-band ord[N] encode the direction parameter indexes for the last subband with the fixed rate approach using bits_dir1 [N−1][0:M−1] bits as shown in FIG. 3 by step 311.

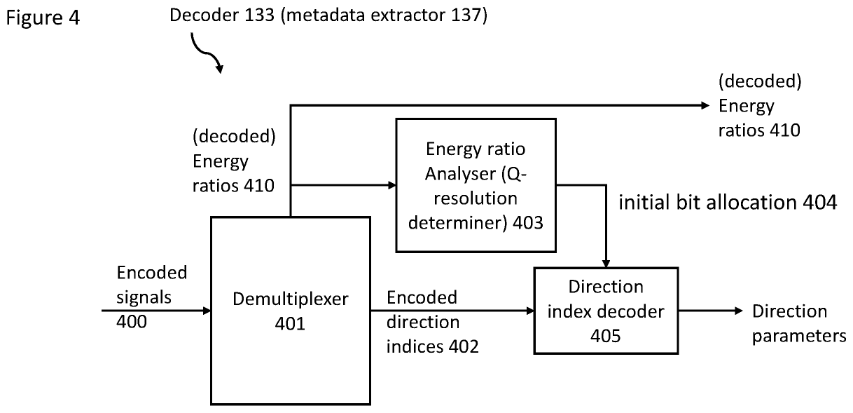

With respect to FIG. 4 is shown an example decoder 133, and specifically an example metadata extractor 137.

In some embodiments the encoded datastream 400 is passed to a demultiplexer 401. The demultiplexer 401 is configured to extract encoded energy ratios and encoded direction indices 402 and may also in some embodiments extract other metadata and transport audio signals (not shown). In some embodiments the demultiplexer 401 is further configured to decode the extracted encoded energy ratios.

The energy ratios (which may be in an encoded or decoded format) in some embodiments are output from the decoder and may also be passed to an energy ratio analyser 403 (quantization resolution determiner). For example as the encoder as shown in FIG. 2 is configured to determine an initial quantization or bit allocation based on the original energy ratios then decoded energy ratios are passed to the energy ratio analyser 403.

In some embodiments the decoder 133 (and specifically the metadata extractor 137) comprises an energy ratio analyser 403 (quantization resolution determiner). The energy ratio analyser 403 is configured to perform a similar analysis to that performed within the metadata encoder energy ratio analyser (quantization resolution determiner) in order to generate an initial bit allocation 404 for the directional information. This initial bit allocation 404 for the directional information is passed to the direction index decoder 405.

In some embodiments where the encoder is configured to determine an initial quantization/bit allocation based on encoded or quantized energy ratio parameters then the decoder/demultiplexer is configured to pass extracted encoded energy ratio parameters to the energy ratio analyser 403 in order to determine the initial bit allocation for the direction parameters.

The direction index decoder 405 may furthermore receive from the demultiplexer encoded direction indices 402.

The direction index decoder 405 may be configured to determine a reduced bit allocation for directional values in a manner similar to that performed within the encoder.

The direction index decoder 405 may then furthermore be configured to read one bit to determine whether all of the elevation data is 0 (in other words the directional values are 2D).

Then the subbands are ordered in an increasing order of average relative bit penalty ord[i], i=1:N.

Where the direction values are 3D then a count value for the last ordered sub-band ord[N] allocation nb_last is determined.

If the value nb_last is 0 then the last ordered sub-band to be decoded is N−1 otherwise the last ordered sub-band to be decoded is N.

The on an ordered sub-band by sub-band basis from the first ordered sub-band ord[1] to the last sub-band (either ord[N] or ord[N−1] according to the previous determination) then the direction index decoder 405 is configured to determine whether the encoding of the current sub-band was encoded using a fixed rate or variable rate code.

Where there was a fixed rate code used at the encoder then the spherical index (or other index distribution) is read and decoded obtaining the elevation and azimuth values and the allocation of bits for the next sub-band is reduced by 1.

Where there was a variable rate code used at the encoder then the entropy encoded index is read and decoded to generate the elevation and azimuth values. Then the number of bits used in the entropy encoded information counted and the difference between the allowed bits for the current ordered sub-band and the bits used in the entropy encoding determined. After this the difference bits are distributed for the succeeding ordered subband(s).

Then the last ordered subband is decoded based on the fixed rate code.

Where the direction values are 2D then for each ordered subband the indices are decoded based on the fixed-rate encoded azimuth indices.

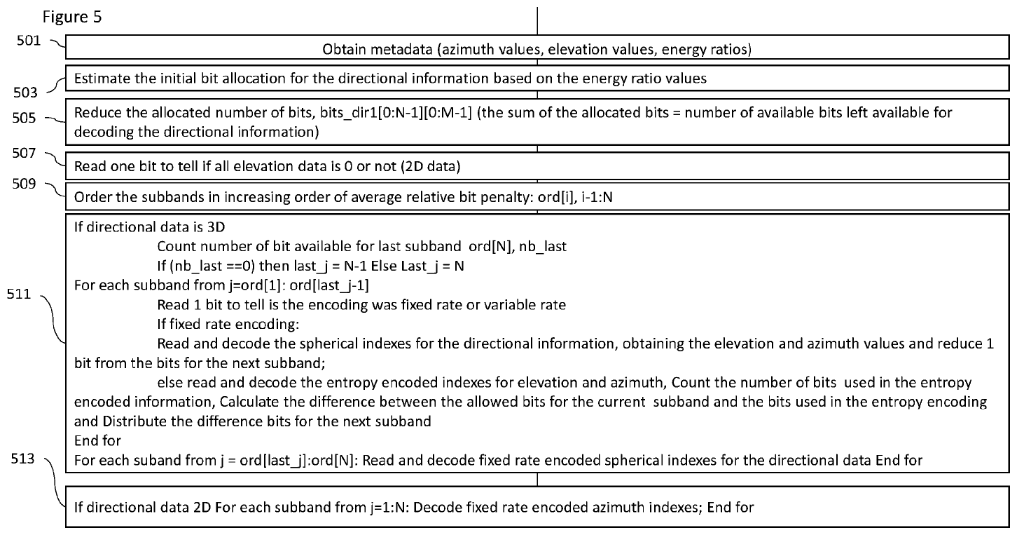

With respect to FIG. 5 is shown a flow diagram of the decoding of the example encoded bit stream is shown.

Thus for example a first operation would be to obtain metadata (azimuth values, elevation values, energy ratios) as shown in FIG. 5 by step 501.

Then the method may estimate the initial bit allocation for the directional information based on the energy ratio values as shown in FIG. 5 by step 503.

The available bit allocation may then be reduced, bits_dir1[0:N−1][0:M−1](the sum of the allocated bits=number of available bits left available for decoding the directional information) as shown in FIG. 5 by step 505.

A bit is then read to determine if all elevation data is 0 or not (2D data) as shown in FIG. 5 by step 507.

Then the subbands are ordered in increasing order of average relative bit penalty: ord[i], i−1:N as shown in Figured 5 by step 509.

If the directional data is 3D then, as shown in FIG. 5 by step 511, then the method may be configured to count the number of bits available for last ordered subband (ord[N]), nb_last. If the number of bits available for the last ordered sub-band is zero (or nb_last==0) then the last subband which is processed in the following loop is the penultimate ordered sub-band. In other words then last_j=N−1 and the index of the subband is ord[N−1]. Otherwise when the number of bits available for the last ordered sub-band is more than one then the last subband which is processed in the following loop is actually the last ordered subband (or Last_j=N).

The method may then be configured to implement a processing loop where for each subband subject to the above subband limit (or from j=ord[1]: ord[last_j−1]) the method may read 1 bit to tell is the encoding was fixed rate or variable rate. If the method used in encoding was fixed rate encoding based on the signalling bit then the method may be configured to read and decode the spherical indexes for the directional information, obtaining the elevation and azimuth values and reduce 1 bit from the bits for the next subband. When the method used in encoding was entropy encoding based on the signalling bit then the method may be configured to read and decode the entropy encoded indexes for elevation and azimuth. The method may then be configured to count the number of bits used in the entropy encoded information calculate the difference between the allowed bits for the current subband and the bits used in the entropy encoding and distribute the difference bits for the next subband.

The method may furthermore for each remaining ordered suband (in other words from j=ord[last_j:N]:ord[N]) be configured to read and decode fixed rate encoded spherical indexes for the directional data.

If the directional data is 2D then for each subband from j=1:N then the method may be configured to decode fixed rate encoded azimuth indexes. This is shown in FIG. 5 by step 513.

The entropy encoding/decoding of the azimuth and the elevation indexes in some embodiments may be implemented using a Golomb Rice encoding method with two possible values for the Golomb Rice parameter. In some embodiments the entropy coding may also be implemented using any suitable entropy coding technique (for example Huffman, arithmetic coding . . . ).

In some embodiments when encoding/decoding the elevation index there may be a couple of exceptions, for the cases where the number of bits used for quantization is less or equal to 3 then based on a determination of distances between direction parameters (or whether the elevation of two direction parameters is similar or within a determined threshold) then the encoding/decoding method may be configured to implement joint or common elevation encoding (in other words using a single elevation value to represent more than one time/subband).

Furthermore where a joint or common elevation encoding is implemented, in some embodiments then azimuth indexes can then be assigned to optimize the distribution of the indices. For example the azimuth indices 7, 5, 3, 1, 0, 2, 4, 6 m be assigned for the values −180, −135, −90, −45, 0, 45, 90, 135.

In some embodiments where there is joint or common elevation encoding implemented then a use context may be determined and the azimuth encoding method is determined or chosen based on the use context determination.

In some embodiments a joint coding is implemented by selecting between entropy coding (EC) and fixed rate coding. In some embodiments the method and apparatus can be modified such that the ordering of the subbands and implicitly the decision of which subband follows is made after the encoding of each subband.

This may be implemented as the following operations:

```
1. Quantize energy ratios for each band
2. Allocate bits to the TF tiles in each subband
based on the quantized energy ratios
3. Reduce the bit allocation in TF tiles
in order to fit into the available bit budget.
4. Calculate the average relative bit penalty for each subband
5. Encode the subband with lowest average
relative bit penalty value and output the number of bits
that can be given to the following subband, B.
6. If B > 0
  a. Select the subband with highest
  penalty value out of the remaining ones
7. Else /* this corresponds B = −1, or B = 0 */
  a. Select the subband with lowest penalty value
  out of the remaining ones
8. End
9. Encode selected subband and output the
number of bits that can be given to next subband
10. If only one subband left
  a. Give it the B bits and encode it in fixed rate
11. Else
  a. Go to 6
12. End
```

In some embodiments the determination of the “quantization accuracy” and the “penalty” can be implemented in different ways. The quantization accuracy in some embodiments can be determined using any suitable measure that can be obtained during the encoding and decoding (directly or transmitted from encoder). For example, it may be a table of perceptibility of errors within different quantization levels based on subjective evaluation. It may also be completely objective measure such as maximum angle error. Likewise, in some embodiments the penalty measure may be based on any of these measures (or a combination of them). Furthermore a ‘perceptibility’ error penalty measure may be defined in some embodiments based on the direction angle (as well as the potential angle difference). For example ‘front’ direction angles, in other words audio signals which are forwards from the user rather than in the rear or the sides of the user can be configured such that any ‘difference’ for example between the initial bit allocation and the reduced bit allocation (or the initial bit allocation possible quantization error) produces a greater penalty value than a similar difference for an side or rear direction angle. For example any obtained penalty can be weighted with the inverse value of the azimuth angle from a corresponding subband from a previous frame.

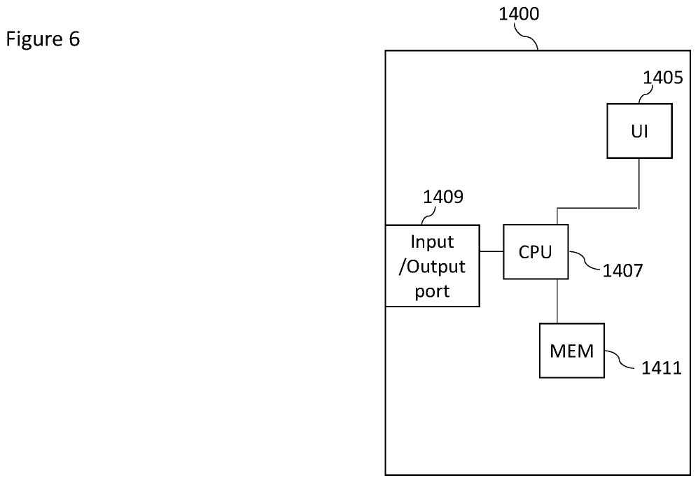

In some embodiments the highest penalty value, from the selecting the subband with highest penalty value out of the remaining ones, can be determined based on the penalty values obtained as if the bits to be distributed were given and not on the original penalty values. Also in some embodiments the lowest penalty value, from the selecting the subband with lowest penalty value out of the remaining ones, can be determined based on the penalty values obtained as if the bits to be distributed were given and not on the original penalty With respect to FIG. 6 an example electronic device which may be used as the analysis or synthesis device is shown. The device may be any suitable electronics device or apparatus. For example in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407.

In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code. Furthermore the device may generate a suitable downmix signal and parameter output to be transmitted to the synthesis device.

In some embodiments the device 1400 may be employed as at least part of the synthesis device. As such the input/output port 1409 may be configured to receive the downmix signals and in some embodiments the parameters determined at the capture device or processing device as described herein, and generate a suitable audio signal format output by using the processor 1407 executing suitable code. The input/output port 1409 may be coupled to any suitable audio output for example to a multichannel speaker system and/or headphones or similar.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware.

The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising at least one processor and at least one memory including computer program code, the at least one memory and the computer program code configured to, with the at least one processor, cause the apparatus to:
obtain values for parameters representing an audio signal, the values comprising at least one directional value and at least one energy ratio value for each sub-band of at least two sub-bands of a frame of the audio signal;
determine a penalty value for each sub-band; and on a sub-band by sub-band basis:
select a sub-band based on the penalty value;
encode, for the selected sub-band, the at least one directional value for each sub-band; and
distribute any bits allocated for encoding the selected sub-band at least one directional value which are not used in the encoding of the at least one directional value to succeeding selections of sub-bands.

2. The apparatus as claimed in claim 1, wherein the apparatus caused to determine a penalty value for each sub-band is caused to:
determine for the sub-bands an initial allocation of bits to encode the directional values of the frame based on the at least one energy ratio values;
determine for the sub-bands a second allocation of bits to encode the directional values of the frame, the second allocation of bits being based on an available number of bits for encoding the values of the frame of the audio signal and a number of bits used in encoding the energy ratio values of the frame of the audio signal;
determine a difference between the initial allocation of bits to encode the directional values and the second allocation of bits to encode the directional values of the frame.

3. The apparatus as claimed in claim 1, wherein the apparatus caused to determine a penalty value for each sub-band is caused to:
obtain a subjective perceptibility error measure associated with allocation of bits to encode the directional values of the frame; and
determine a penalty value based on the obtained perceptibility error measure.

4. The apparatus as claimed in claim 1, wherein the apparatus caused to determine a penalty value for each sub-band is caused to:
determine a weighting factor for each sub-band based on a direction value for a respective sub-band; and
determine the penalty value for each sub-band based on the determined weighting factor.

5. The apparatus as claimed in claim 2, wherein the apparatus caused to select a sub-band based on the penalty value is caused to: order the sub-bands based on the difference between the initial allocation of bits to encode the directional values and the second allocation of bits to encode the directional values of the frame relative to the initial allocation of bits to encode the directional values; and select, on the sub-band by sub-band basis, the sub-bands based on the ordering of the sub-bands.

6. The means as claimed in claim 2, wherein the bits allocated for encoding the selected sub-band at least one directional value are based on the second allocation of bits to encode the directional values of the frame and any previous selected sub-band distribution.

7. The apparatus as claimed in claim 1, wherein the apparatus caused to select a sub-band based on the penalty value is caused to select an unencoded sub-band with the lowest penalty value.

8. The apparatus as claimed in claim 7, wherein the apparatus caused to distribute any bits allocated for encoding the selected sub-band at least one directional value which are not used in the encoding of the at least one directional value to succeeding selections of sub-bands is caused to distribute to a sub-band yet to be selected with the highest penalty value any bits allocated for encoding the selected sub-band at least one directional value which are not used in the encoding of the at least one directional value.

9. The apparatus as claimed in claim 1, wherein the apparatus is further caused to redetermine penalty values for each yet to be selected sub-band based on the distributing any bits allocated for encoding the selected sub-band at least one directional value which are not used in the encoding of the at least one directional value to succeeding selections of sub-bands.

10. (canceled)

11. The apparatus as claimed in claim 1, wherein the apparatus is further caused to encode the at least one energy ratio values of the frame by:
generating a weighted average of the at least one energy ratio value; and
encoding the weighted average of the at least one energy ratio value.

12. The apparatus as claimed in claim 11, wherein the caused to encode the weighted average of the at least one energy ratio value is further caused to scalar non-uniform quantize the at least one weighted average of the at least one energy ratio value.

13. The apparatus as claimed in claim 1, wherein the apparatus caused to encode, for the selected sub-band, the at least one directional value for each sub-band, is further caused to:
determine a first number of bits required by encoding the at least one directional value for the selected sub-band based on a quantization grid;
determine a second number of bits required by entropy encoding the at least one directional value for the selected sub-band;
select either the quantization grid encoding or entropy encoding based on the lower number of bits used from the first number and the second number; and
generate a signalling bit identifying the selection of the quantization grid encoding or entropy encoding.

14. (canceled)

15. (canceled)

16. An apparatus comprising at least one processor and at least one memory including computer program code, the at least one memory and the computer program code configured to, with the at least one processor, cause the apparatus to:
obtain encoded values for parameters representing an audio signal, the encoded values comprising at least one encoded directional value and at least one encoded energy ratio value for each sub-band of at least two sub-bands of a frame of the audio signal;
determine a penalty value for each sub-band; and on a sub-band by sub-band basis:
select a sub-band based on the penalty value;
decoding decode, for the selected sub-band, the at least one directional value for each sub-band; and
determine for succeeding selections of sub-bands a number of bits allocated for the encoded values of the at least one directional value.

17. The apparatus as claimed in claim 16, wherein the apparatus caused to determine a penalty value for each sub-band is caused to:
determine for the sub-bands an initial allocation of bits for encoding the directional values of the frame based on the at least one energy ratio values;
determine for the sub-bands a second allocation of bits which for encoding the directional values of the frame, the second allocation of bits being based on an available number of bits for encoding the directional values of the frame of the audio signal and a number of bits used in encoding the energy ratio values of the frame of the audio signal; and
determine a difference between the initial allocation of bits to encode the directional values and the second allocation of bits to encode the directional values of the frame.

18. The apparatus as claimed in claim 16, wherein the apparatus caused to determine a penalty value for each sub-band is caused to:
obtain a subjective perceptibility error measure associated with allocation of bits to encode the directional values of the frame; and
determine a penalty value based on the obtained perceptibility error measure.

19. The apparatus as claimed in claim 16, wherein the apparatus caused to determine a penalty value for each sub-band is caused to:
determine a weighting factor for each sub-band based on a direction value for a respective sub-band; and
determine the penalty value for each sub-band based on the determined weighting factor.

20. The apparatus as claimed in in claim 17, wherein the apparatus caused to select a sub-band based on the penalty value is caused to: order the sub-bands based on the difference between the initial allocation of bits to encode the directional values and the second allocation of bits to encode the directional values of the frame relative to the initial allocation of bits to encode the directional values; and select, on the sub-band by sub-band basis, the sub-bands based on the ordering of the sub-bands.

21. The means as claimed in claim 17, wherein the bits allocated for encoding the selected sub-band at least one directional value are based on the second allocation of bits for encoding the directional values of the frame and any previous selected sub-band distribution.

22. The apparatus as claimed in claim 16, wherein the apparatus caused to select a sub-band based on the penalty value is caused to select an encoded sub-band with the lowest penalty value.

23. The apparatus as claimed in claim 22, wherein the apparatus caused to distribute any bits allocated for encoding the selected sub-band at least one directional value which are not used in the encoding of the at least one directional value to succeeding selections of sub-bands is caused to distribute to a sub-band yet to be selected with the highest penalty value any bits allocated for encoding the selected sub-band at least one directional value which are not used in the encoding of the at least one directional value.

24. The apparatus as claimed in claim 16, wherein the apparatus is further caused to redetermine penalty values for each yet to be selected sub-band based on the distributing any bits allocated for encoding the selected sub-band at least one directional value which are not used in the encoding of the at least one directional value to succeeding selections of sub-bands.

25. (canceled)

26. The apparatus as claimed in claim 16, wherein the apparatus caused to decode, for the selected sub-band, the at least one directional value for each sub-band, is further caused to:
determine a signalling bit; and
select either a quantization grid decoding or entropy decoding based on the signalling bit.

27-29. (canceled)
